(19) United States
(12) Patent Application Publication
(10) Pub. No.: US 2011/0107201 A1
(43) Pub. Date: May 5, 2011

(54) REPRESENTING COMPLEX DOCUMENT STRUCTURE VIA SIMPLER STRUCTURE THROUGH ISOMORPHISM

(75) Inventors: Youn Gon Kim, University Place, WA (US); Byung Kun Lee, Sammamish, WA (US); Cristiano Suzuki, Redmond, WA (US); Christian Gaarden Gaardmark, Redmond, WA (US); Dag Schmidtke, Dublin (IE)

(73) Assignee: Microsoft Corporation, Redmond, WA (US)

(21) Appl. No.: 12/608,575

(22) Filed: Oct. 29, 2009

(51) Int. Cl. G06F 17/00

(52) U.S. Cl. 715/236

(57) ABSTRACT

A complex document can be transformed into a simple representation through isomorphism such that the content of the document can be subjected to machine or human translation without distraction by the style and structure of the document. The isomorphed simple representation is also transformable to the original complex document without losing stylistic or structural elements.

### BACKGROUND

In the early days of computing, documents mainly contained textual data and were stored as binary files. Historically, these files were difficult to interoperate with other applications. As computing capabilities developed, documents became increasingly complex. In today's documents it is common to expect a wide variety of attributes associated with textual data (e.g. font types, sizes, artistic variations, etc.). Furthermore, documents also include other types of data such as tables, graphics, images, and a number of different “objects”. Moreover, interoperability between various applications such as word processing applications, spreadsheet applications, presentation applications, and comparable ones is also a common characteristic expected by users.

The increasing complexity of documents meant binary files would be larger and larger. Interoperability using binary files became also more difficult. A solution to the format challenge was structured files such as markup language files. Today, markup language formats such as Extensible Markup Language (XML) files are commonly used to store documents making it easy to avail those to different applications and handle data of any complexity.

However, a complex document format like Open Document Format (ODF) or OpenXml is difficult to translate. The schema complexity, the declarative style, and structural markups mixed with the actual content obfuscate the content for machine and human translations. Translators (both human and machine) are typically unable to distinguish what needs to be translated (content) over what should not be translated (style). This may cause translators to break the document or to miss translating part of the document.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to transforming a complex document into a simple representation through isomorphism such that the content of the document can be subjected to machine or human translation without distraction by the style and structure of the document. Further embodiments provide a method for transforming the isomorphed simple representation to the original complex document without losing stylistic or structural elements.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example simple document;

FIG. 2 illustrates an example complex document;

FIG. 3 illustrates a fragment of an example XML document, which is too complex to be translated, and its simplified representation through isomorphism;

FIG. 4 illustrates transformation of the fragment of FIG. 3 to a tree structure prior to isomorphism according to embodiments;

FIG. 5 illustrates first level of isomorphism of the fragment of FIG. 3 during simplification according to embodiments;

FIG. 6 illustrates second level of isomorphism of the fragment of FIG. 3 during simplification according to embodiments;

FIG. 7 illustrates final level of isomorphism of the fragment of FIG. 3 during simplification according to embodiments;

FIG. 8 illustrates the final level of isomorphism of the fragment of FIG. 3 along with a first level of reverse transformation following translation of the simplified fragment;

FIG. 9 illustrates second level of reverse transformation following the translation as shown in FIG. 8;

FIG. 10 illustrates final level of reverse transformation back to the complex document of the translated content according to embodiments;

FIG. 11 is a networked environment, where a system according to embodiments may be implemented;

FIG. 12 is a block diagram of an example computing operating environment, where isomorphism according to embodiments may be implemented; and

FIG. 13 illustrates a logic flow diagram for a process of isomorphing a complex document to a simplified representation according to embodiments.

### DETAILED DESCRIPTION

As briefly described above, a complex document can be transformed into a simple representation through isomorphism such that the content of the document can be subjected to machine or human translation without distraction by the style and structure of the document. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, the term “platform” may be a combination of software and hardware components for providing word processing, spreadsheet, presentation, and similar services that utilize documents. Examples of platforms include, but are not limited to, a hosted service executed over a plurality of servers, an application executed on a single server, and comparable systems. The term “server” refers to a computing device executing one or more software programs typically in a networked environment. The term “client” refers to a computing device or software application that provides a user access to data and other software applications through a network connection with other clients and/or servers. More detail on these technologies and example operations is provided below.

An isomorphism from Greek ison (equal) and morphe (shape) is a bijective map ƒ such that both f and its inverse ƒ⁻¹ are homomorphisms, i.e., structure-preserving mappings. For example, a group is an algebraic object consisting of a set together with a single binary operation, satisfying certain axioms. If G and Hare groups, a homomorphism from G to His a function ƒ: G→H such that ƒ(a*b)=ƒ(a)+ƒ(b) for any elements a, b ε G, where the first * denoting the operation in G, and the second + denoting the operation in H.

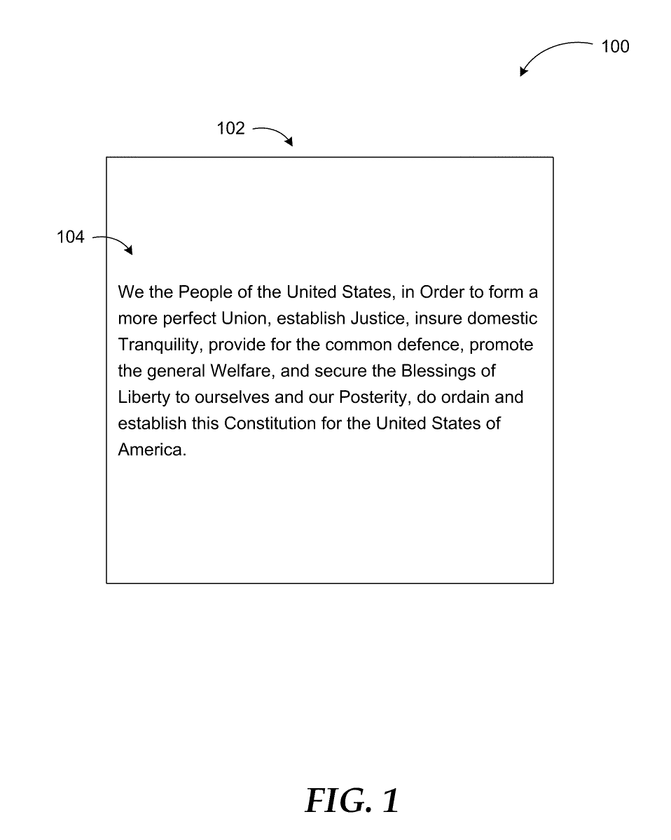

FIG. 1 illustrates diagram 100 of example simple document 102. Simple document 102 includes textual content 104, where the text is in simple form, i.e. no style variations, layout variations, or other behavior aspects that are common in today's documents.

Textual content 104 is simply a string of characters. As such, the document may be stored as a binary file with each character being represented as a byte, for example. Since no property or behavior elements are used, the document does not need a complex structure. For an application focusing on the content, such as a translation application, the document is easy to use without distraction by non-content elements.

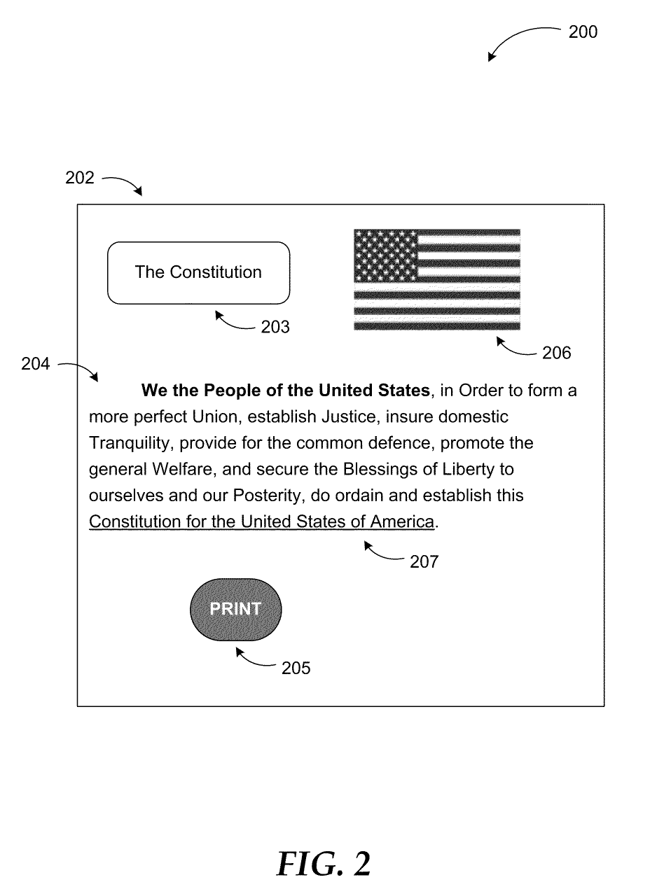

FIG. 2 illustrates diagram 200 of an example complex document 202. In contrast with the simple documents discussed above, complex documents may include a variety of properties and behavior associated with their content. For example, textual content 204 of complex document 202 may include style, font size, font type, and similar behaviors associated with different portions of it. Furthermore, additional elements such as hyperlinks 207 (to a document or a network location) may be inserted into the presented content. Graphical elements, images, audio, video, etc. may also be included in the document (e.g. flag 206, textbox 203, button 205, etc.). Moreover, a layout of the document (e.g. placement of textual content, direction, grouping, etc.) may be as complex as one desires.

Since simple file structures such as binary files would be insufficient or inefficient to represent/store such complex documents, structured document files have evolved over the last decade. Markup language files, specifically Extensible Markup language (XML) files are one example of creating and storing such complex documents.

By definition, an XML document is a string of characters. Almost every legal Unicode character may appear in an XML document. Differently from simple documents, however, XML documents include content and markup (hence the markup language). Markup constructs that begin with a “<” and end with a “>” define properties associated with presentation of content, links to other documents and network destinations, and comparable characteristics. Examples of markup constructs include tags such as start or end tags, attributes (a name/value pair that exists within a start-tag or empty-element tag), and others.

The non-content elements of complex documents such as XML documents control the behavior of the document and its elements in various aspects. However, those elements are distinct from content elements (textual content). Some applications such as translation are mainly focused on the content. For example, machine translation applications typically consider words and/or sentences. Most of the behaviors controlled by the non-content elements of a complex document are not only useless for the machine translation application, but they may often distract the application. Similarly, human translation may also be degraded by the complex behavior of content within a complex document.

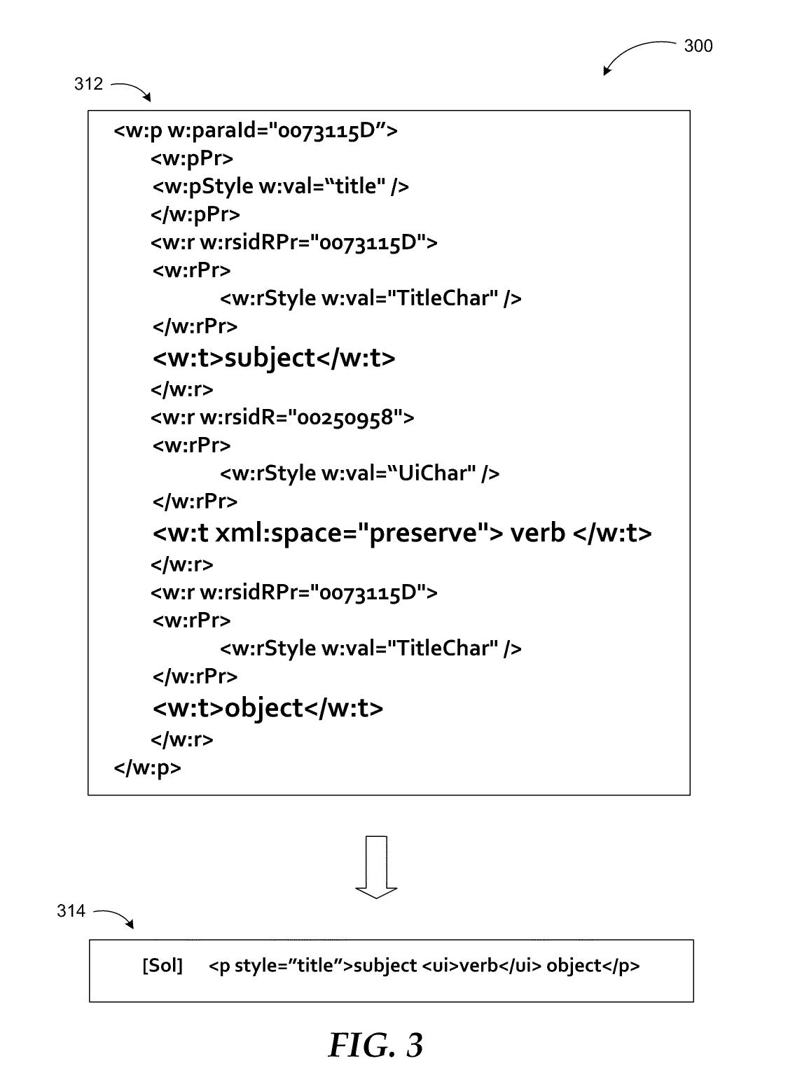

FIG. 3 illustrates a fragment of an example XML document, which is too complex to be translated, and its simplified representation through isomorphism. Document 312 in diagram 300 includes an XML document with content (e.g. “lorem” and “lpsum”) along with markup elements such as paragraph identifier tags, style tags, and section format tags.

In a system according to embodiments, the entire complex document 312 is transformed to its isomorphed version 314 such that content specific operations such as translation can be performed. The isomorphed version 314 includes the style of the content (title) and the content itself. Thus, any human or machine translation operation cannot be distracted by the additional markups.

The transformation may be performed by an application processing the document (e.g. a word processing application), a separate module, a separate application, or a module integrated into the application processing the document (e.g. an add-on module). In case the user is machine-translating the document, the information that is passed to the machine translation (MT) engine is solely the content that actually need translation, which comes from the isomorphed version 314 of the complex document 312. Once the MT engine returns the translated results, the translation may be applied to the isomorphed version 314 and converted back to the original complex representation. At the end of this process, the user sees the original complex document 312 but translated. The transformation process may be applied to the entire document or to a user-selected portion (e.g. word, sentence, paragraph etc.).

Every other aspect of the complex document 312 that is not to be translated is kept intact during this process. For example, if the user performs any layout modification to the document, the action is done on the complex document 312. Furthermore, translation may be enabled on certain complex elements such as hyperlinks or text associated with graphical elements. For example, if a document including advertising for a company is translated from English to French, hyperlinks within the document referring to company resources in the US (or England) may be translated to links for company resources in France and incorporated back into the complex document. Similarly, textual content within graphical elements may be separately isomorphed into the simple version, translated, and then incorporated back into the complex document 312. Alternatively, elements such as those discussed above may be preserved depending on default parameters, user preferences, and the like.

During the transformation and translation process, both document representations (complex and isomorphed) may be maintained updated, which enables side-by-side comparison and synchronization. As described below, the transformation of the complex document into the isomorphed version (and the reverse transformation) is performed through multiple levels of compression and normalization. The information for preservation of the complex document (e.g. layout, styles, etc.) may be maintained in a separate document or in memory. This mapping information may be stored as a separate file, as part of the complex document, or cached and discarded at the end of the process. Similarly, the isomorphed version may be stored as a separate file, as part of the complex document, or cached and discarded at the end of the process.

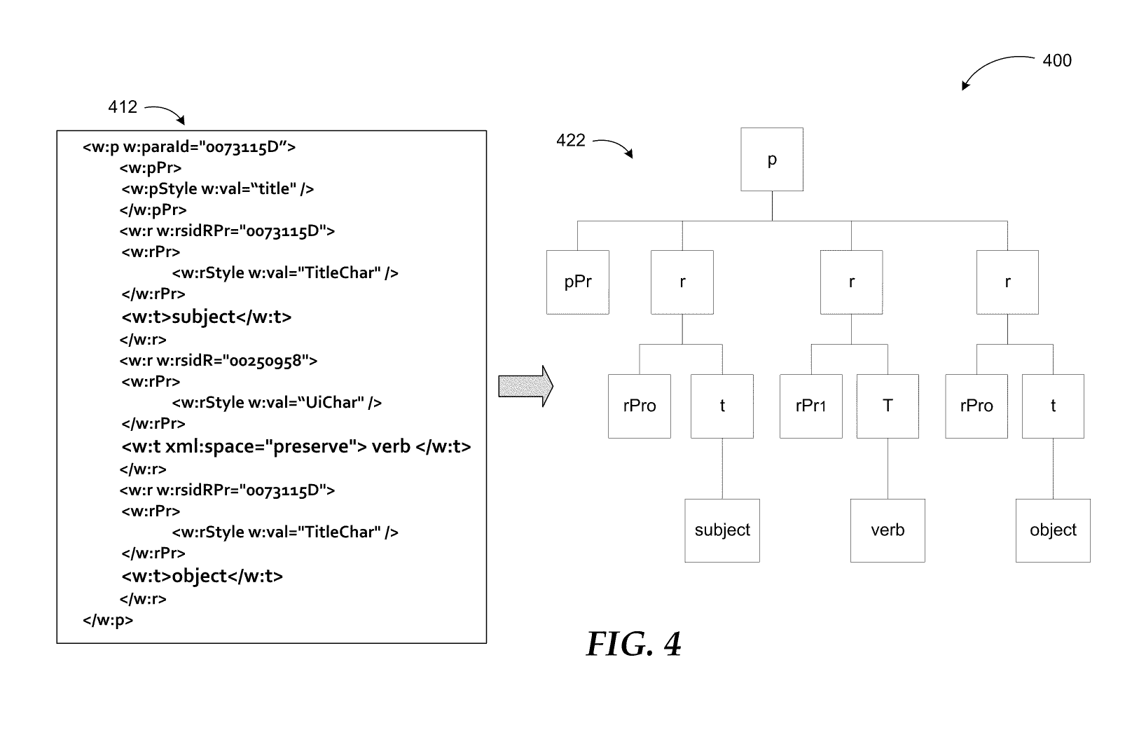

FIG. 4 illustrates transformation of the fragment of FIG. 3 into a tree structure prior to isomorphism according to embodiments. Diagram 400 shows the node representation 422 of the complex document 412. Structured documents such as XML documents are typically structured based on nodes, which represent segments of the documents such as paragraphs, sentences, words, etc. The nodes defined in the complex document may be represented in a tree structure visually providing relationships between the nodes of the document with the content presented at the bottom level.

According to some embodiments, the tree structure of the complex document may be transformed into the isomorphed version by compressing and normalizing child nodes of each node of a given level (e.g. words to sentences, sentences to paragraphs, etc.). The transformation process is performed in steps, where each steps includes compression and normalization of child nodes of all nodes of a level, until the entire document is isomorphed to the simplified version.

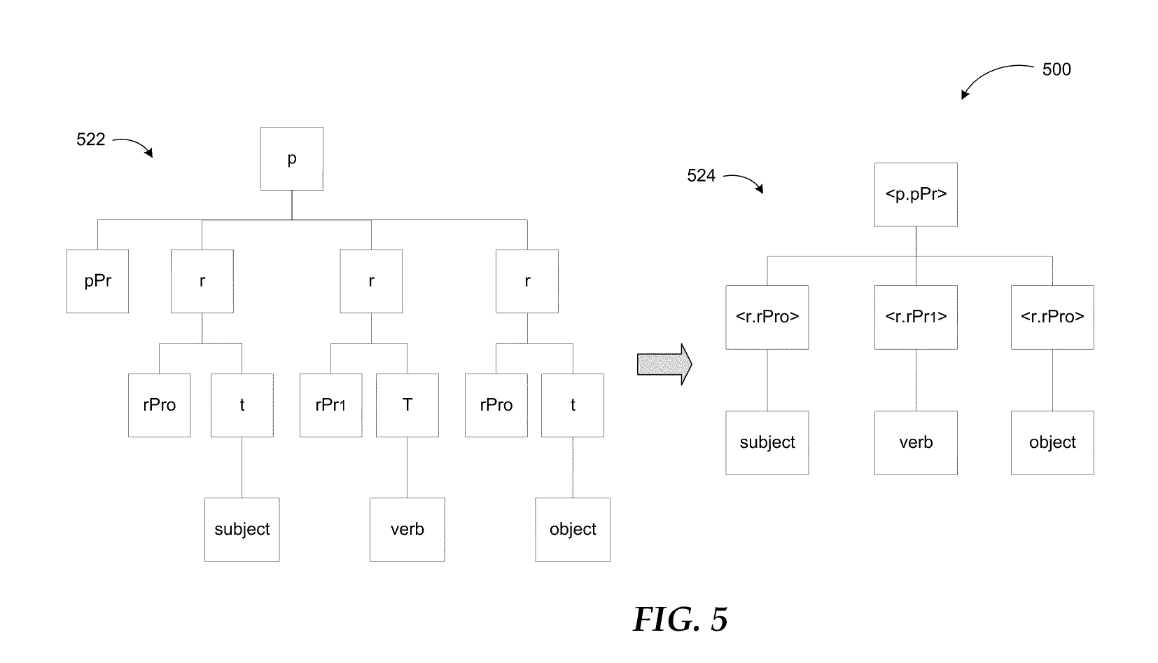

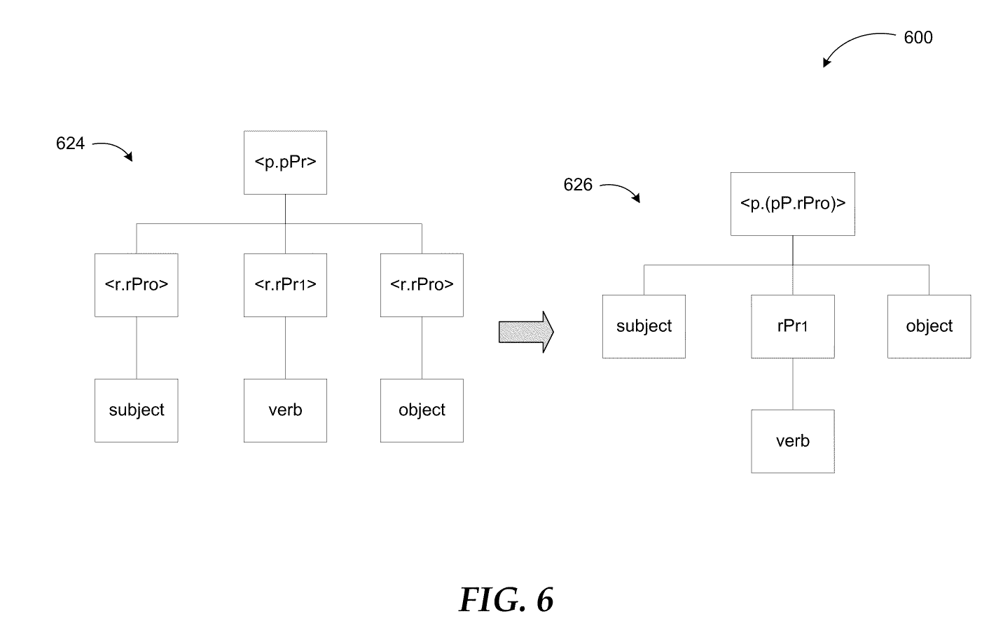

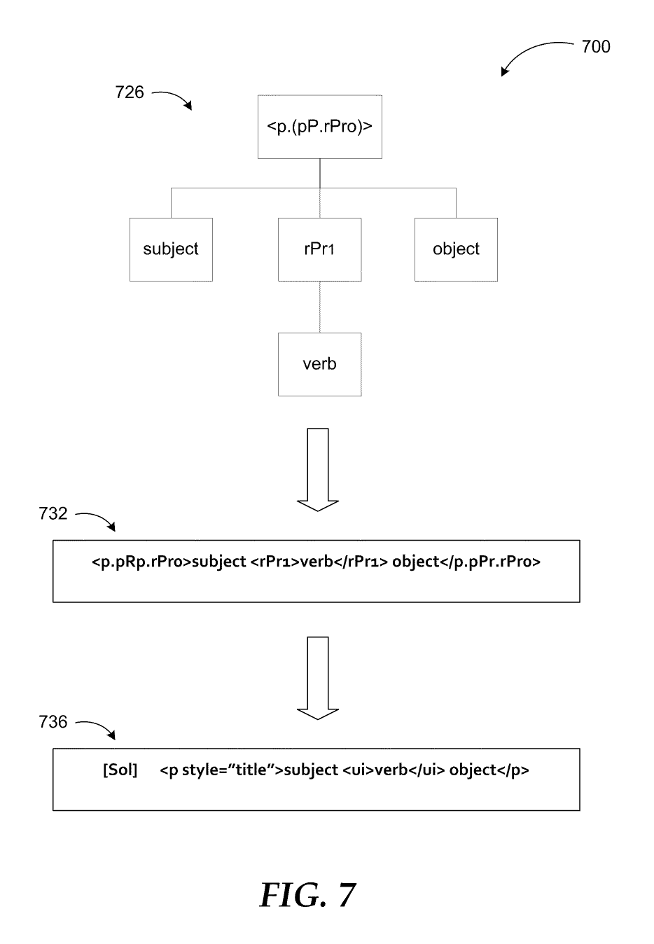

FIGS. 5, 6, and 7 illustrate the isomorphism (f) of the fragment of FIG. 3 through three steps of compression and normalization according to embodiments. Diagram 500 of FIG. 5 shows how the tree structure 522 of the complex document 312 of FIG. 3 can be compressed (and normalized) to the tree structure 524 (default property as a dot pair). The obtained tree structure (624) is further compressed and normalized to tree structure 626 as shown in diagram 600 of FIG. 6 (non-default property), which is the final level before the tree structure is converted to markup version. The markup version (732) of the final compressed tree structure 726 and the simplified document 736 obtained from the markup version 732 are shown in diagram 700 of FIG. 7.

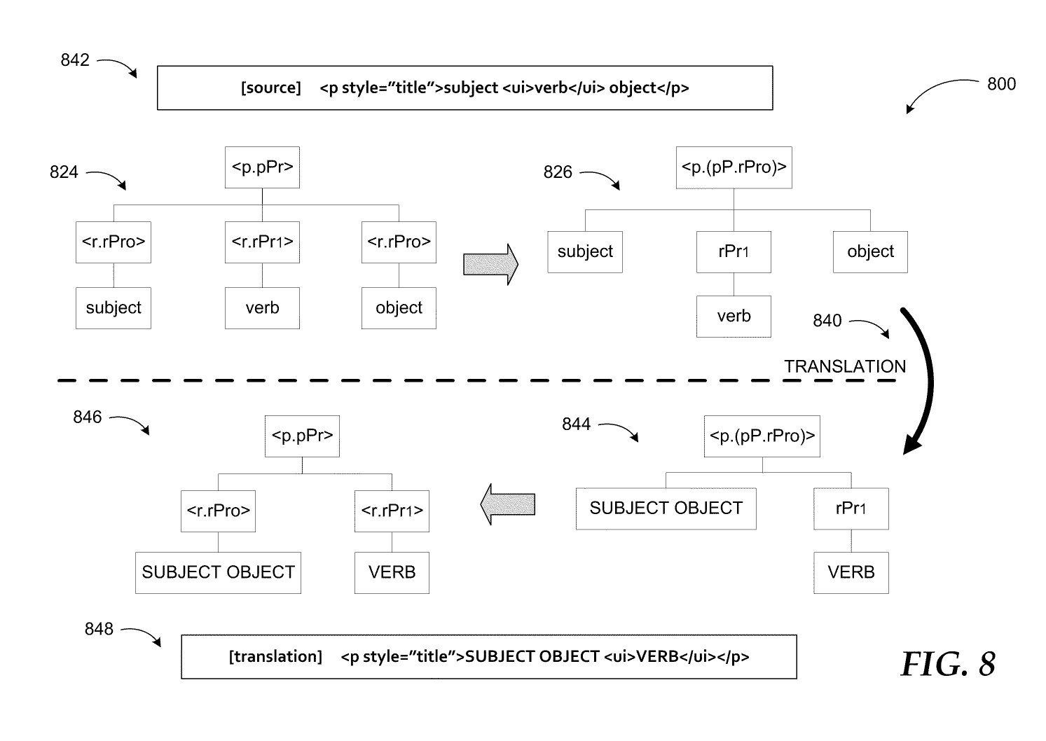

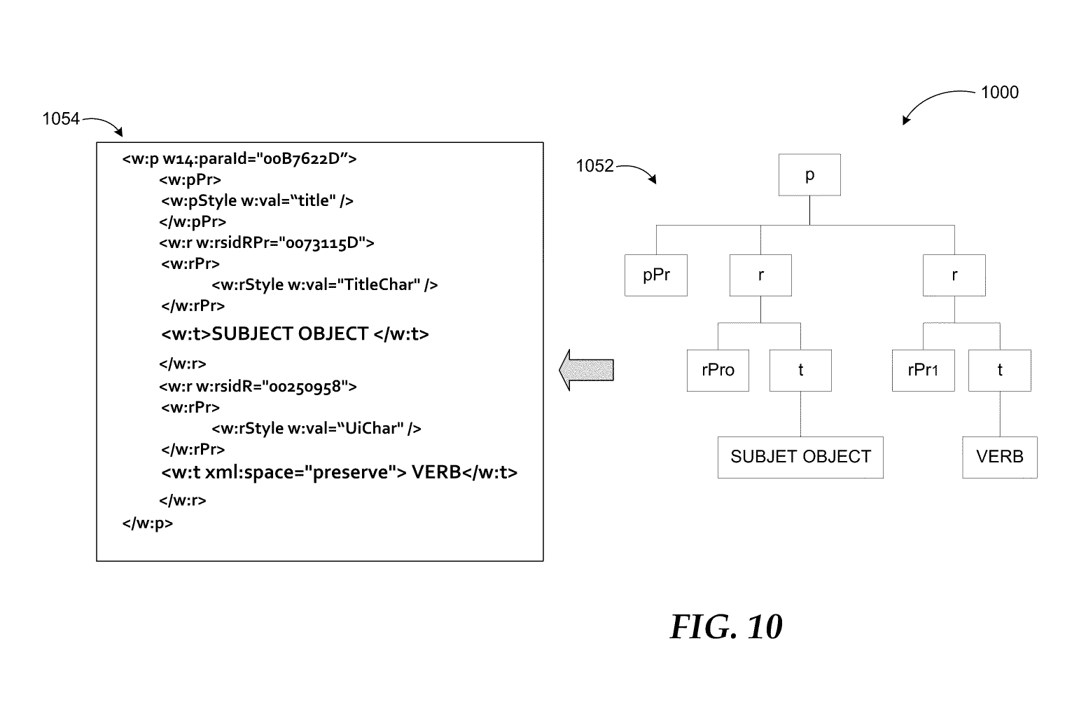

FIGS. 8, 9, and 10 illustrate the reconstruction process (f¹) for the original complex document following a translation of the simplified version. As shown in diagram 800 of FIG. 8, source data 842 (<p style=“title”>subject<ui>verb</ui>object</p>) is obtained through the final isomorphism between tree structures 824 and 826. Following translation 840, which may be machine or manual translation, translated data 848 (<p style=“title”>SUBJECT OBJECT<ui>VERB</ui></p>) is represented as basic compressed tree structure 844, which is reverse transformed to a higher level (decompressed) tree structure 846. As shown in the example, the order of words in the translated document is different due to grammatical differences between languages.

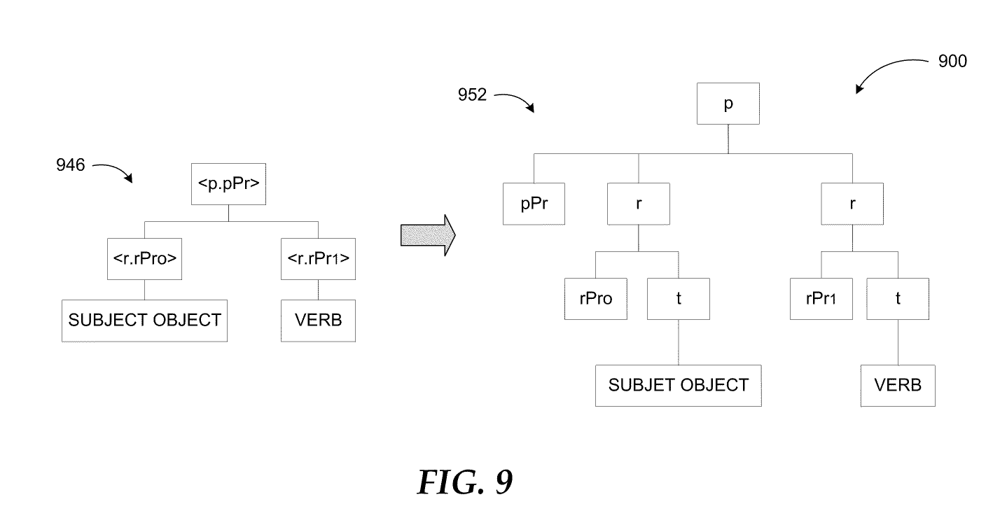

Diagram 900 of FIG. 9 illustrates the reverse transformation of the tree structure derived in FIG. 8 (denoted as 946 in diagram 900) to the fully decompressed tree structure 952 by opening the default property dot pairs. In the following figure, diagram 1000 shows how the complex document 1054 is obtained from the fully decompressed tree structure 1052. Complex document 1054 is a translated version of the original complex document 312 of FIG. 3 with its content translated but all other properties preserved.

While embodiments have been discussed above using a general framework, they are intended to provide a general guideline to be used to transform complex documents into simplified documents through isomorphism and reverse. Specific algorithms for performing the isomorphism may be implemented using the principles described herein.

While the examples in FIG. 2 through FIG. 10 have been described with specific documents, elements, and aspects, embodiments are not limited to these configurations and can be implemented with other elements and configurations. Furthermore, embodiments are not limited to using isomorphism based transformation for translation purposes. Complex documents may be simplified for other processing purposes and reversed as discussed herein.

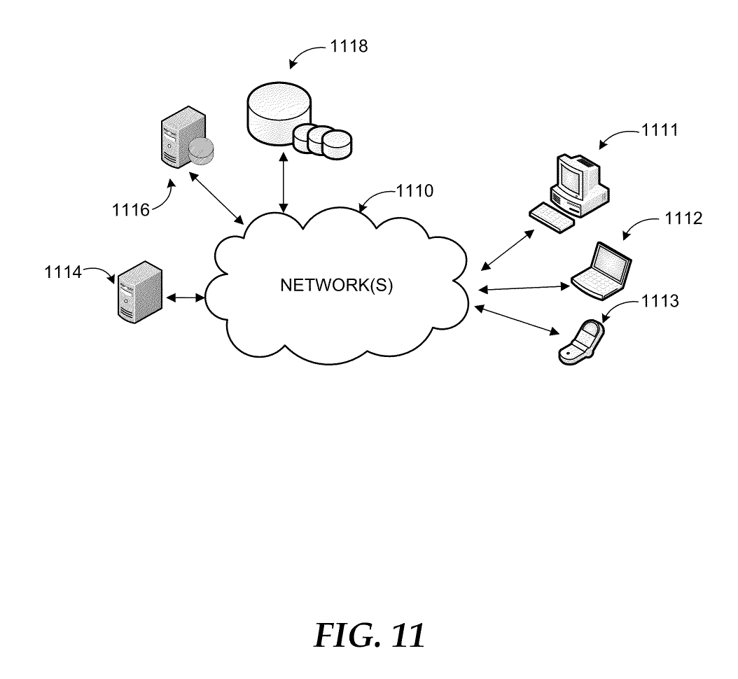

FIG. 11 is an example networked environment, where embodiments may be implemented. A platform providing document transformation services through isomorphism may be implemented via software executed over one or more servers (e.g. server 1114) such as a hosted service. The platform may communicate with applications on individual computing devices such as a desktop computer 1111, laptop computer 1112, and smart phone 1113 (‘client devices’) through network(s) 1110.

Client devices 1111-1113 are capable of communicating through a variety of modes and exchange documents. An application executed in one of the client devices or one of the servers (e.g. server 1114) may store and retrieve data associated with the transformation of documents (to simpler representation and back to original complex form) to and from a number of sources such as data stores 1118, which may be managed by any one of the servers or by database server 1116.

Network(s) 1110 may comprise any topology of servers, clients, Internet service providers, and communication media. A system according to embodiments may have a static or dynamic topology. Network(s) 1110 may include a secure network such as an enterprise network, an unsecure network such as a wireless open network, or the Internet. Network(s) 1110 may also comprise a plurality of distinct networks. Network(s) 1110 provides communication between the nodes described herein. By way of example, and not limitation, network(s) 1110 may include wireless media such as acoustic, RF, infrared and other wireless media.

Many other configurations of computing devices, applications, data sources, and data distribution systems may be employed to implement a system transforming complex documents to a simpler representation through isomorphism. Furthermore, the networked environments discussed in FIG. 11 are for illustration purposes only. Embodiments are not limited to the example applications, modules, or processes.

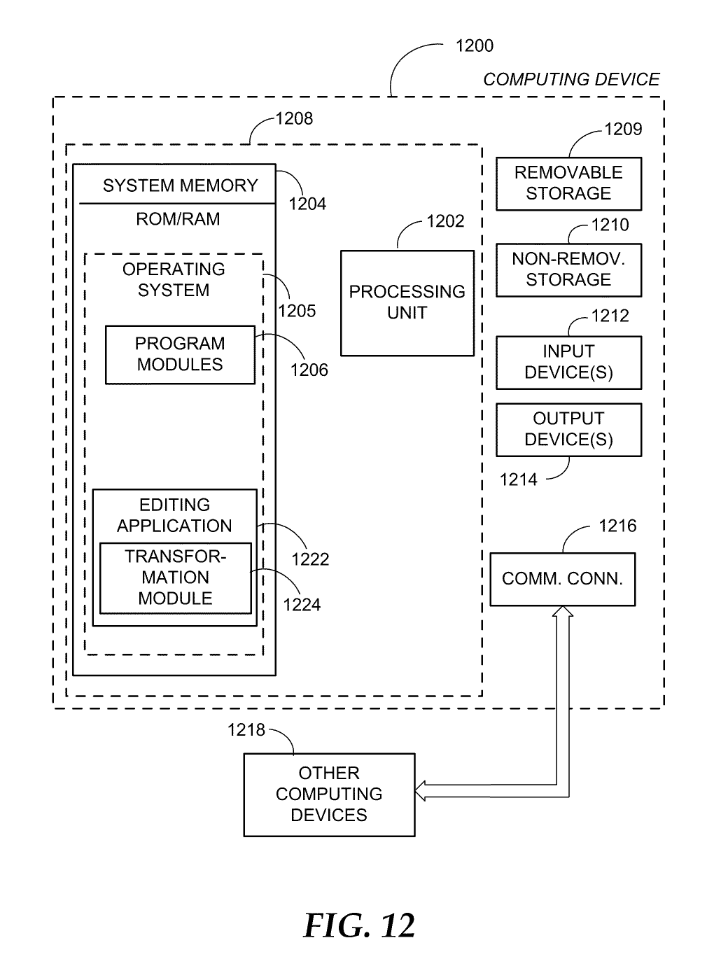

FIG. 12 and the associated discussion are intended to provide a brief, general description of a suitable computing environment in which embodiments may be implemented. With reference to FIG. 12, a block diagram of an example computing operating environment for an application according to embodiments is illustrated, such as computer 1200. In a basic configuration, computer 1200 may include at least one processing unit 1202 and system memory 1204. Computer 1200 may also include a plurality of processing units that cooperate in executing programs. Depending on the exact configuration and type of computing device, the system memory 1204 may be volatile (such as RAM), non-volatile (such as ROM, flash memory, etc.) or some combination of the two. System memory 1204 typically includes an operating system 1205 suitable for controlling the operation of the platform, such as the WINDOWS® operating systems from MICROSOFT CORPORATION of Redmond, Wash. The system memory 1204 may also include one or more software applications such as program modules 1206, editing application 1222, and transformation module 1224.

Editing application 1222 may be a word processing application, a spreadsheet application, a presentation application, or a similar one that processes documents including complex documents. Transformation module 1224 may be a separate application or an integral module of editing application 1222. Transformation module 1224 may, among other things, transform a complex document into a simple representation through isomorphism in multiple levels and transform the simple representation back to the original form as discussed in more detail above. This basic configuration is illustrated in FIG. 12 by those components within dashed line 1208.

Computer 1200 may have additional features or functionality. For example, the computer 1200 may also include additional data storage devices (removable and/or non-removable) such as, for example, magnetic disks, optical disks, or tape. Such additional storage is illustrated in FIG. 12 by removable storage 1209 and non-removable storage 1210. Computer readable storage media may include volatile and nonvolatile, removable and non-removable media implemented in any method or technology for storage of information, such as computer readable instructions, data structures, program modules, or other data. System memory 1204, removable storage 1209 and non-removable storage 1210 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computer 1200. Any such computer readable storage media may be part of computer 1200. Computer 1200 may also have input device(s) 1212 such as keyboard, mouse, pen, voice input device, touch input device, and comparable input devices. Output device(s) 1214 such as a display, speakers, printer, and other types of output devices may also be included. An interactive display may act both as an input device and output device. These devices are well known in the art and need not be discussed at length here.

Computer 1200 may also contain communication connections 1216 that allow the device to communicate with other devices 1218, such as over a wireless network in a distributed computing environment, a satellite link, a cellular link, and comparable mechanisms. Other devices 1218 may include computer device(s) that execute other applications such as translation applications and so on. Communication connection(s) 1216 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

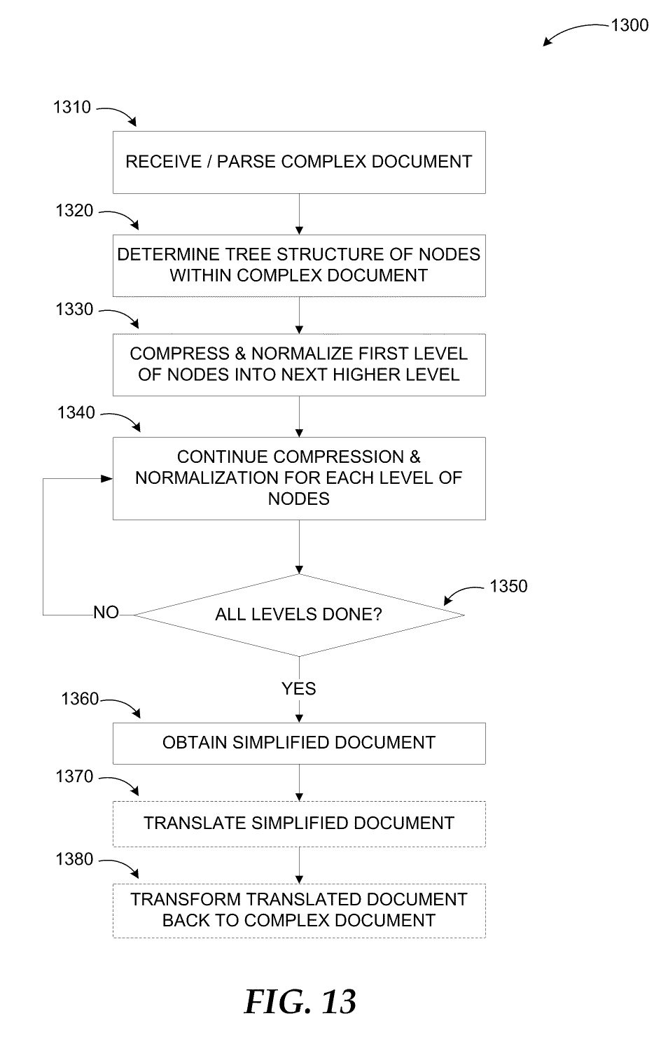

FIG. 13 illustrates a logic flow diagram for a process 1300 of isomorphing a complex document to a simplified representation according to embodiments. Process 1300 may be implemented by any application processing documents such as the ones described above.

Process 1300 begins with operation 1310, where a complex document is received and parsed. A tree structure of the complex document is determined at operation 1320. An iterative process of compressing and normalizing each level of nodes is performed between operations 1330 and 1350 until all levels are compressed and normalized.

The simplified version of the complex document is obtained from the compressed and normalized node structure at operation 1360. The isomorphed document may be translated at optional operation 1370, which is followed by optional operation 1380, where the translated document is transformed back to the complex document through a reverse of the above described algorithm.

The operations included in process 1300 are for illustration purposes. Transforming complex documents into a simpler representation through isomorphism for translation purposes may be implemented by similar processes with fewer or additional steps, as well as in different order of operations using the principles described herein.

Thus, a method for transforming a complex document into a simplified document according to some embodiments includes receiving the complex document with content and non-content markup elements; transforming the complex document into the simplified document through an iterative isomorphism process by compressing and normalizing a node structure of the complex document; receiving a processed version of the simplified document; and transforming the processed simplified document into the complex document through a reverse iterative isomorphism process while preserving the node structure of the complex document. The complex document may then be presented to a user.

The processing of the simplified document may include machine translation or human translation. The iterative isomorphism process may include parsing the received complex document to determine the node structure of the complex document; compressing and normalizing a lowest level of child nodes to their respective parent nodes; compressing and normalizing each level of nodes until all levels are exhausted; and deriving the simplified document from the compressed and normalized node structure of the complex document.

The non-content markup elements may include textual style elements, textual behavior elements, layout elements, graphical elements, images, audio, video, hyperlinks, and similar ones. The hyperlinks and textual content associated with the graphical elements may also be translated or preserved depending on a default parameter or user preference. An intermediary structure may be employed to preserve the non-content markup elements of the complex document during the transformation and reverse transformation processes. The intermediary structure may be stored in memory or a separate document. The simplified document may be stored as a separate document, stored in cache and discarded upon completion of the reverse transformation, or stored as part of the complex document.

According to other embodiments, a computing device may execute an application that performs the actions of the method described above. The transformation may be performed by the application, by another application, or by an integrated module of the application. Similarly, the translation may be performed by the application, by another application, or by an integrated module of the application. The application may maintain updated versions of the complex document and the simplified document during the transformation and the reverse transformation processes enabling comparison and synchronization of the documents. The simplified document may be stored in memory during the transformation and reverse transformation processes and discarded upon completion of the reverse transformation process. Moreover, the application may be a word processing application, a spreadsheet application, a presentation application, a communication application, or a browser application.

The actions of the method described above may also be stored as computer-executable instructions stored in a computer-readable medium according to further embodiments. The simplified document may be obtained by transforming the entire complex document or a user-selected portion of the complex document. According to yet other embodiments, selected non-textual elements in the complex document may be translated based on a default parameter or a user selection.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for transforming a complex document into a simplified document, the method comprising:
receiving the complex document that includes content and non-content markup elements;
transforming the complex document into the simplified document through an iterative isomorphism process by compressing and normalizing a node structure of the complex document;
receiving a processed version of the simplified document;
transforming the processed simplified document into the complex document through a reverse iterative isomorphism process while preserving the node structure of the complex document; and
presenting the complex document to a user.

2. The method of claim 1, wherein the processed version of the simplified document is obtained through one of: machine translation and human translation of the simplified document.

3. The method of claim 1, wherein the iterative isomorphism process includes:
parsing the received complex document to determine the node structure of the complex document;
compressing and normalizing a lowest level of child nodes to their respective parent nodes;
compressing and normalizing each level of nodes until all levels are exhausted; and
deriving the simplified document from the compressed and normalized node structure of the complex document, wherein the non-content markup elements are removed in the simplified document.

4. The method of claim 1, wherein the non-content markup elements include at least one from a set of: textual style elements, textual behavior elements, layout elements, graphical elements, images, audio, video, and hyperlinks.

5. The method of claim 4, wherein the simplified document is translated prior to the reverse transformation, and wherein the hyperlinks and textual content associated with the graphical elements are also translated.

6. The method of claim 4, wherein the simplified document is translated prior to the reverse transformation, and wherein the hyperlinks and textual content associated with the graphical elements are preserved.

7. The method of claim 1, wherein the non-content markup elements of the complex document are preserved during the transformation and reverse transformation processes.

8. The method of claim 7, further comprising:
employing an intermediary structure to preserve the non-content markup elements of the complex document during the transformation and reverse transformation processes.

9. The method of claim 8, wherein the intermediary structure is stored in one of: a memory and a separate document.

10. The method of claim 1, wherein the simplified document is one of: stored as a separate document, stored in cache and discarded upon completion of the reverse transformation, and stored as part of the complex document.

11. A computing device providing document processing, the computing device comprising:
a memory;
a processor coupled to the memory, the processor executing an application configured to:
receive a complex document;
parse the complex document to obtain a node structure of the complex document;
transform the complex document into a simplified document through an iterative isomorphism process by compressing and normalizing the node structure of the complex document;
receive a processed version of the simplified document;
transform the processed simplified document back into the complex document through a reverse iterative isomorphism process while preserving the node structure of the complex document; and
a display device for presenting the complex document to a user.

12. The computing device of claim 11, wherein processing of the simplified document includes translation of content elements in the complex document, and the translation is performed by one of: the application, another application, and a translation module integrated into the application.

13. The computing device of claim 12, wherein processing of the simplified document further includes one of: translation of selected non-content elements and preservation of the selected non-content elements based on at least one of: a default parameter and a user preference.

14. The computing device of claim 11, wherein the application is further configured to maintain updated versions of the complex document and the simplified document during the transformation and the reverse transformation processes enabling comparison and synchronization of the documents.

15. The computing device claim 11, wherein the simplified document is stored in the memory during the transformation and reverse transformation processes and discarded upon completion of the reverse transformation process.

16. The computing device of claim 11, wherein the application is one of: a word processing application, a spreadsheet application, a presentation application, a communication application, and a browser application.

17. A computer-readable storage medium having instructions stored thereon for transforming a complex document into a simplified document, the instructions comprising:
receiving the complex document that includes content and non-content markup elements;
parsing the received complex document to determine the node structure of the complex document;
compressing and normalizing a lowest level of child nodes to their respective parent nodes;
compressing and normalizing each level of nodes until all levels are exhausted;
deriving the simplified document from the compressed and normalized node structure of the complex document, wherein non-content markup elements are removed in the simplified document;
translating the simplified document;
transforming the translated simplified document back into the complex document through a reverse iterative isomorphism process while preserving the node structure of the complex document; and
presenting the complex document to a user.

18. The computer-readable storage medium of claim 17, wherein the simplified document is obtained by transforming one of: the entire complex document and a user-selected portion of the complex document.

19. The computer-readable storage medium of claim 17, wherein a layout of the content, a behavior of the content, and non-textual elements in the complex document are preserved during the transformation and the reverse transformation through an intermediary structure.

20. The computer-readable storage medium of claim 17, wherein selected non-textual elements in the complex document are translated based on one of: a default parameter and a user selection.
